(19) United States
(12) Patent Application Publication
(10) Pub. No.: US 2017/0156969 A1
(43) Pub. Date: Jun. 8, 2017

(54) Foot Massaging Assembly

(71) Applicant: John Fitzsimmons, Redmond, OR (US)

(72) Inventor: John Fitzsimmons, Redmond, OR (US)

(21) Appl. No.: 14/959,206

(22) Filed: Dec. 4, 2015

(51) Int. Cl. A61H 15/00

(52) U.S. Cl. CPC A61H 15/00; A61H 2015/0042

(57) ABSTRACT

A foot massaging assembly for massaging a foot includes a base that may be positioned on a support surface. A pair of mounts is provided and each of the mounts is coupled to the base. A massage unit is rotatably coupled between the mounts. The massage unit may have a foot rolled thereon thereby facilitating the massage unit to massage the foot.

### BACKGROUND OF THE DISCLOSURE

### Field of the Disclosure

The disclosure relates to massaging devices and more particularly pertains to a new massaging device for massaging a foot.

### SUMMARY OF THE DISCLOSURE

An embodiment of the disclosure meets the needs presented above by generally comprising a base that may be positioned on a support surface. A pair of mounts is provided and each of the mounts is coupled to the base. A massage unit is rotatably coupled between the mounts. The massage unit may have a foot rolled thereon thereby facilitating the massage unit to massage the foot.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a foot massaging assembly according to an embodiment of the disclosure.

FIG. 2 is a top view of an embodiment of the disclosure.

FIG. 3 is a perspective in-use view of an embodiment of the disclosure.

FIG. 4 is a bottom view of an embodiment of the disclosure.

FIG. 5 is an exploded perspective view of an embodiment of the disclosure.

### DESCRIPTION OF THE PREFERRED EMBODIMENT

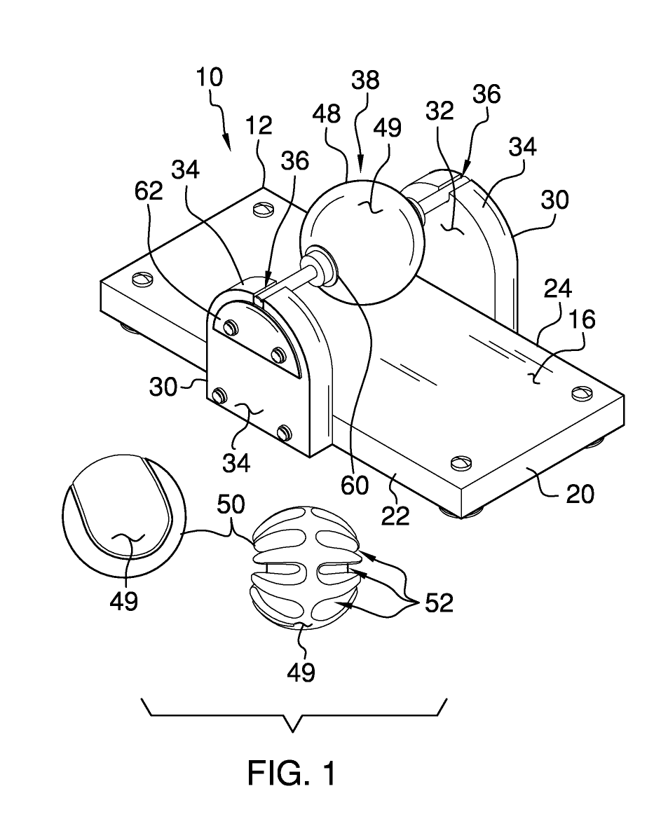

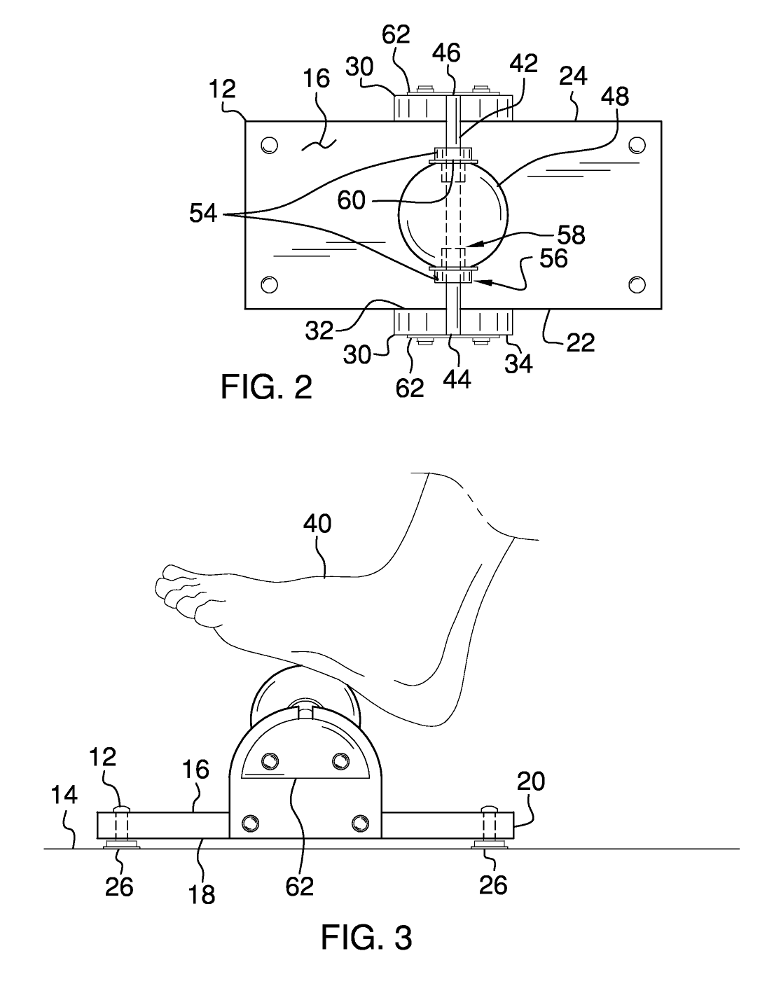

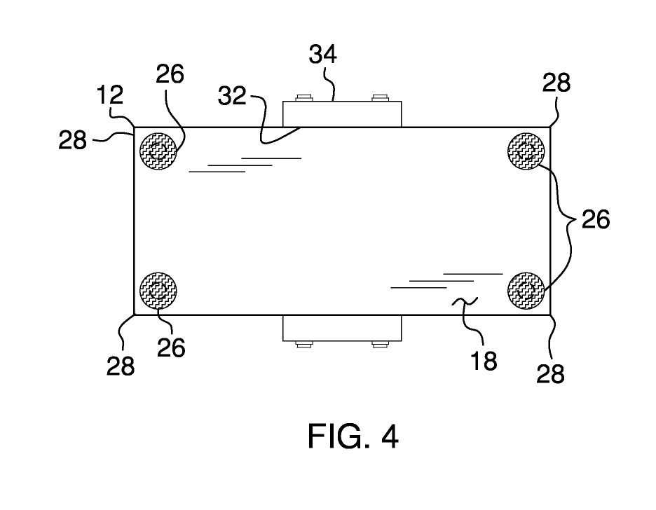

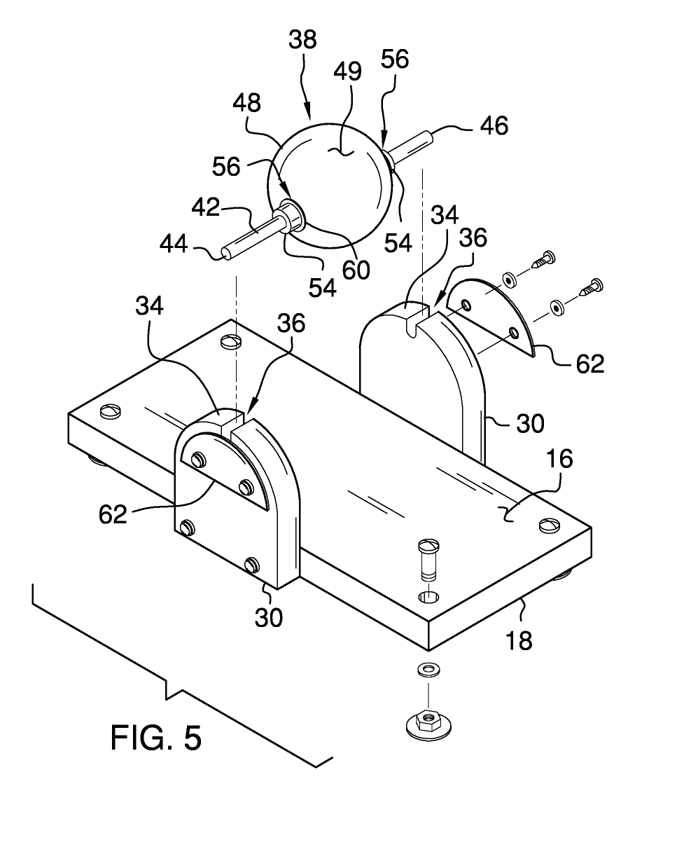

With reference now to the drawings, and in particular to FIGS. 1 through 5 thereof, a new massaging device embodying the principles and concepts of an embodiment of the disclosure and generally designated by the reference numeral 10 will be described.

As best illustrated in FIGS. 1 through 5, the foot massaging assembly 10 generally comprises a base 12 that may be positioned on a support surface 14. The base 12 has a top surface 16, a bottom surface 18 and a peripheral edge 20 extending between the top surface 16 and the bottom surface 18. The peripheral edge 20 has a first lateral side 22 and a second lateral side 24. The support surface 14 may comprise a floor or the like.

A plurality of feet 26 is provided and each of the feet 26 is coupled to the bottom surface 18 of the base 12. Thus, each of the feet 26 may abut the support surface 14. Each of the feet 26 are positioned proximate an associated one of four corners 28 of the base 12. Each of the feet 26 is comprised of a material having a high coefficient of friction. Thus, the base 12 is inhibited from sliding along the support surface 14.

A pair of mounts 30 is provided and each of the mounts 30 is coupled to the base 12. Each of the mounts 30 has a first surface 32 and a second surface 34. The first surface 32 of each of the mounts 30 is coupled to an associated one of the first lateral side 22 and the second lateral side 24 of the base 12. Each of the mounts 30 is centrally positioned on the base 12. Each of the mounts 30 extends upwardly from the top surface 16 to define a distal end 34 of each of the mounts 30 with respect to the top surface 16.

The distal end 34 of each of the mounts 30 may be rounded. The distal end 34 of each the mounts 30 has a slot 36 extending downwardly therein. The slot 36 in each of the mounts 30 extends through the first surface 32 and the second surface 34 of an associated one of the mounts 30. Additionally, the slot 36 is centrally positioned on the distal end 34 of the associated mount 30.

A massage unit 38 is rotatably coupled between the mounts 30 and the massage unit 38 may have a foot 40 rolled thereon thereby facilitating the massage unit 38 to massage the foot 40. The massage unit 38 comprises a shaft 42 that has a first end 44 and a second end 46. The shaft 42 is positioned in the slot 36 in each of the mounts 30 such the shaft 42 extends between the mounts 30. Thus, the shaft 42 is removably coupled to each of the mounts 30 and the shaft 42 is spaced from the base 12.

A ball 48 is provided and the ball 48 has the shaft 42 extending through a center of the ball 48. Thus, the ball 48 may have the foot 40 positioned against the ball 48 thereby facilitating the ball 48 to massage the foot 40. The ball 48 has an outer surface 49 and the ball 48 may be one of a plurality of balls 50. The outer surface 49 of one of the balls 50 may be textured thereby enhancing friction of the ball 50 against the foot 40. The outer surface 49 of one of the balls 50 may have a plurality of openings 52 extending therethrough thereby enhancing friction of the balls 50 against the foot 40.

A pair of retainers 54 is provided and each of the retainers 54 has a first portion 56 and a second portion 58. The first portion 56 has a diameter that is greater than a diameter of the second portion 58. The first portion 56 of each of the retainers 54 has a bounding edge 60. Each of the retainers 54 is positioned around the shaft 42 such that the each of the retainers 54 is coupled to the shaft 42. Each of the retainers 54 is positioned proximate an associated one of the mounts 30.

Each of the retainers 54 is positioned on opposite sides of the ball 48. The second portion 58 of each of the retainers 54 extends into the ball 48. The ball 48 may rotate freely on the second portion 58 of each of the retainers 54. The ball 48 may be fixed to the second portion 58 of each of the retainers 54. The ball 48 may rotate when the foot 40 is positioned against the ball 48. The ball 48 abuts the bounding edge 60 of each of the retainers 54 such that the ball 48 is retained at a central position with respect to the shaft 42.

A pair of stops 62 is provided and each of the stops 62 is removably coupled to the second surface 34 of an associated one of the mounts 30. Each of the stops 62 covers the slot 36 in the second surface 34 in the associated mount 30. Thus, the first end 44 and the second end 46 of the shaft 42 abuts an associated one of the stops 62. Each of the stops 62 inhibits the shaft 42 from travelling laterally with respect to the mounts 30 when the ball 48 is rotated. Each of the stops 62 may be coupled to the associated mount 30 using a screw 64 or the like.

In use, the base 12 is positioned on the support surface 14. The foot 40 is rolled backwardly and forwardly on the ball 48. The ball 48 frictionally engages the foot 40 such that the foot 40 is massaged. The shaft 42 is removable from the slots 36 at any time.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A foot massaging assembly comprising:
a base being configured to be positioned on a support surface;
a pair of mounts, each of said mounts being coupled to said base; and
a massage unit being rotatably coupled between said mounts wherein said massage unit is configured to have a foot rolled thereon thereby facilitating said massage unit to massage the foot.

2. The assembly according to claim 1, wherein said base has a top surface, a bottom surface and a peripheral edge extending between said top surface and said bottom surface, said peripheral edge having a first lateral side and a second lateral side.

3. The assembly according to claim 2, further comprising a plurality of feet, each of said feet being coupled to said bottom surface of said base wherein each of said feet is configured to abut the support surface, each of said feet being positioned proximate an associated one of four corners of said base.

4. The assembly according to claim 2, wherein each of said mounts has a first surface and a second surface, said first surface of each of said mounts being coupled to an associated one of said first lateral side and said second lateral side of said base, each of said mounts being centrally positioned on said base, each of said mounts extending upwardly from said top surface to define a distal end of each of said mounts with respect to said top surface.

5. The assembly according to claim 4, wherein said distal end of each said mounts has a slot extending downwardly therein, said slot in each of said mounts extending through said first surface and said second surface of an associated one of said mounts.

6. The assembly according to claim 1, wherein:
each of said mounts has a slot; and
said massage unit comprises a shaft having a first end and a second end, said shaft being positioned in said slot in each of said mounts such said shaft extends between said mounts, said shaft being removably coupled to each of said mounts, said shaft being spaced from said base.

7. The assembly according to claim 6, further comprising a pair of retainers, each of said retainers having a first portion and a second portion, said first portion having a diameter being greater than a diameter of said second portion, each of said retainers being positioned around said shaft such that said each of said retainers is coupled to said shaft, each of said retainers being positioned proximate an associated one of said mounts.

8. The assembly according to claim 7, further comprising:
a ball; and
said first portion of each of said retainers extending into said ball such that said ball rotates freely on said first portion of each of said retainers wherein said ball is configured to rotate when the foot is positioned against said ball, said ball abutting said second portion of each of said retainers such that said ball is retained at a central position with respect to said shaft.

9. The assembly according to claim 5, further comprising:
a shaft having a first end and a second end; and
a pair of stops, each of said stops being removably coupled to said second surface of an associated one of said mounts, each of said stops covering said slot in said associated mount such that said first end and said second end of said shaft abuts an associated one of said stops, each of said stops inhibiting said shaft from travelling laterally with respect to said mounts when said ball is rotated.

10. A foot massaging assembly comprising:
a base being configured to be positioned on a support surface, said base having a top surface, a bottom surface and a peripheral edge extending between said top surface and said bottom surface, said peripheral edge having a first lateral side and a second lateral side;
a plurality of feet, each of said feet being coupled to said bottom surface of said base wherein each of said feet is configured to abut the support surface, each of said feet being positioned proximate an associated one of four corners of said base;
a pair of mounts, each of said mounts being coupled to said base, each of said mounts having a first surface and a second surface, said first surface of each of said mounts being coupled to an associated one of said first lateral side and said second lateral side of said base, each of said mounts being centrally positioned on said base, each of said mounts extending upwardly from said top surface to define a distal end of each of said mounts with respect to said top surface, said distal end of each said mounts having a slot extending downwardly therein, said slot in each of said mounts extending through said first surface and said second surface of an associated one of said mounts;
a massage unit being rotatably coupled between said mounts wherein said massage unit is configured to have a foot rolled thereon thereby facilitating said massage unit to massage the foot, said massage unit comprising:
a shaft having a first end and a second end, said shaft being positioned in said slot in each of said mounts such said shaft extends between said mounts, said shaft being removably coupled to each of said mounts, said shaft being spaced from said base,
a ball having said shaft extending therethrough wherein said ball is configured to have the foot positioned against said ball thereby facilitating said ball to massage the foot, and
a pair of retainers, each of said retainers having a first portion and a second portion, said first portion having a diameter being greater than a diameter of said second portion, each of said retainers being positioned around said shaft such that said each of said retainers is coupled to said shaft, each of said retainers being positioned proximate an associated one of said mounts, said first portion of each of said retainers extending into said ball such that said ball rotates freely on said first portion of each of said retainers wherein said ball is configured to rotate when the foot is positioned against said ball, said ball abutting said second portion of each of said retainers such that said ball is retained at a central position with respect to said shaft; and
a pair of stops, each of said stops being removably coupled to said second surface of an associated one of said mounts, each of said stops covering said slot in said associated mount such that said first end and said second end of said shaft abuts an associated one of said stops, each of said stops inhibiting said shaft from travelling laterally with respect to said mounts when said ball is rotated.
